(19) United States
(12) Patent Application Publication
(10) Pub. No.: US 2009/0272032 A1
(43) Pub. Date: Nov. 5, 2009

(54) Flower pot plant hold up device

(76) Inventor: Herbert J. Kiff, SR., Houma, LA (US)

Correspondence Address: THE INVENTORS NETWORK, INC., 332 ACADEMY STREET, CARNEGIE, PA, 15106, US

(21) Appl. No.: 12/150,555

(22) Filed: Apr. 30, 2008

(51) Int. Cl. A01G 9/12

(52) U.S. Cl. 47/70

(57) ABSTRACT

A flower pot plant hold up device for training a plant to grow straight and tall includes a base for placement within a flower pot and a support pole vertically extending from the base and eccentrically mounted thereto so that the plant grows upward from the center of the flower pot. The support pole includes a plurality of apertures spaced along its vertical extension with each aperture capable of receiving therein an arm that is oriented at a 35 degree angle relative to the vertical extension of the support pole and wherein the trunk, stem, limbs, and branches of the plant are tied to the arms, and as the plant grows straight along the support pole various parts of the plant can be untied and retied to the arms to accommodate the upward growth of the plant and arms can be inserted and removed as needed to also accommodate the plant's straight and tall growth.

### FIELD OF THE INVENTION

The present invention pertains to stands and supports for plants, and more particularly pertains to a pot insert that is designed to train a plant to grow straight and tall.

### BACKGROUND OF THE INVENTION

For any type of flora, be it a houseplant or flower, a vine, shrub, or tree, the ability to grow straight and tall is every bit an essential requirement as having adequate water and sunlight. Thus, in nature one of the primary factors that inhibits and thwarts the growth of any type of fauna is the inability or failure to grow straight and tall. Such inhibitions and impediments can include lack of adequate sunlight because of location or dominance by larger flora, heavy wind or rain that bends the flora and from which they are unable to recover, or an abundant and excessive growth of fruit whose weight permanently bends the limbs and branches thereby impeding further growth and development. All of these factors—and others such as disease and drought—led to poor growth and development, and often an early death.

With the popularity of gardening, home remodeling and renovation, and the emphasis on ecologically friendly and adaptive designs and layouts of commercial and residential structures, as well as the widespread use of flora of all kinds—flowers, plants, vines, shrubs, trees—to decorate and enhance the interior and exterior of all manner of dwellings, devices to encourage the growth of flora in a straight and tall manner are highly desirable. Moreover, the outlets and stores—nurseries, lawn and garden centers, big box retailers—that sell all many of plants and flowers have an obvious economic incentive in presenting and selling healthy flora, and thus any device or support will be sought out that encourages and enhances the straight and tall growth of the flora. Thus, the prior art discloses a variety of plant supports.

For example, the England device (U.S. Pat. No. 4,040,208) discloses a plant holder and anchor that includes a flowerpot having an inverted unshaped wire member attached to the sides of the flowerpot and which includes apertures through which the plant extends and for anchoring the growing plant.

The Mottmiller et al. patent (U.S. design Pat. No. 305,800) discloses a planter trellis having a lower end secured to a flowerpot and diagonal member extending between supports on or upon which the plant grows and is intertwined.

The Warmerdam et al. patent (U.S. Pat. No. 6,609,333 B2) discloses a plant support and container lifting device and which includes a handle from which first and second longitudinal members extend for engaging a container at their lower end and from which they are detachable.

The Warren patents (U.S. Pat. Nos. 6,895,713 B2 and 6,983,561 B2 and US patent application pub. No. US2005/0166449 A1) disclose a vertical plant stand that includes hook style appendages from which plant pots can be mounted.

Nonetheless, despite the ingenuity of the above devices, there remains a need for a plant hold up device that can be slipped into pots of various sized and includes detachable arms that can accommodate and support the upward growth of the plant.

### SUMMARY OF THE INVENTION

The present invention comprehends a flower pot plant hold up device or pot inset that trains and encourages any type of flora—such a typical house plant—to grow straight and tall. The device can be used by homeowners as well as professional landscapers, gardeners, nurseries—indeed, anywhere that plants are located for practical as well as aesthetic reasons.

Thus, the flower pot plant hold up device includes a round base having bumper feet projecting from the bottom of the base and which helps to stabilize the device when placed within the dirt-filled cavity of a typical flower pot or container. Projecting upwardly from the base is a support pole. The support pole is eccentrically located on the base so that the plant can grow up from the center of the flowerpot. The support pole includes a plurality of apertures spaced along its vertical extension, and insertably removable within the apertures are elongated rods. The rods are preferably 36 inches long and are disposed at a 35-degree angle relative to the vertical orientation of the support pole. In operation the plant is simply tied to the rods as the plant grows, and as the plant grows straight and tall, the stem as well as the branches and limbs can be tied, untied, and retied to different rods thereby accommodating and facilitating the straight and tall growth of the plant.

It is an object of the present invention to provide a flower pot plant hold up device that is a convenient product at the retail level.

It is another object of the present invention to provide a flower pot plant hold up device that can be easily placed into variously sized pots and containers for training a tall plant to grow straight and upright.

It is still another object of the present invention to provide a flower pot plant hold up device that enables nurseries and lawn and garden stores and centers their flowers and plants for sale.

It is yet another object of the present invention to provide a flower pot plant hold up device that is constructed of durable and lightweight material so that the device can be easily stored and transported.

It is still yet another object of the present invention to provide a flower pot plant hold up device that allows growers to maintain their plants longer in stock while maintaining their appearance.

Still yet another object of the present invention is to provide a flower pot plant hold up device that assists landscapers in enhancing the visual appeal of the products.

These and other objects, advantages, and features will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the flower pot plant hold up device of the present invention illustrating a plant growing up beside and being supported by the device, with the base of the device seated within a flowerpot;

FIG. 2 is a perspective view of the flower pot plant hold up device of the present invention illustrating the full extension of the support pole of the device;

FIG. 3 is a perspective view of the flower pot plant hold up device of the present invention illustrating the alignment of the device with the pot so that the base of the device can be seated within the pot;

FIG. 4 is a top plan view of the flower pot plant hold up device of the present invention illustrating the insertion of the support rods into the support pole;

FIG. 5 is a side elevational view of the flower pot plant hold up device of the present invention illustrating the support pole mounted to and extending upwardly from the base and the bumper feet;

FIG. 6 is a perspective view of the flower pot plant hold up device of the present invention illustrating a number of arms mounted to and projecting from the support pole at the desired angle of 35 degrees with respect to the vertical support pole and the support pole being circular-shaped;

FIG. 6a is a sectioned elevational view of the flower pot plant hold up device of the present invention illustrating the angled sidewall of one aperture located on the support pole; and

FIG. 7 is a top plan view of the flower pot plant hold up device of the present invention illustrating the eccentric mounting of the support pole to the base and the support pole having a circular-shape.

### DETAILED DESCRIPTION OF THE PREFERRED EMBODIMENT

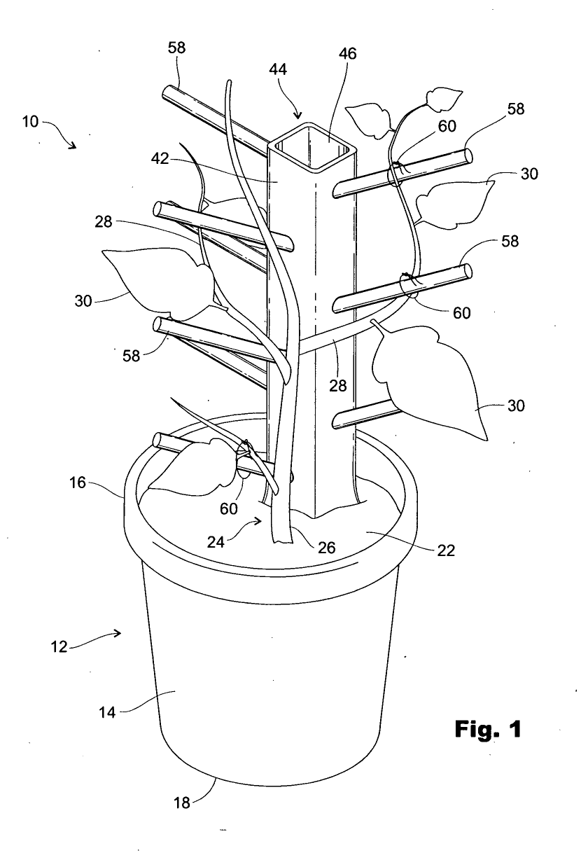

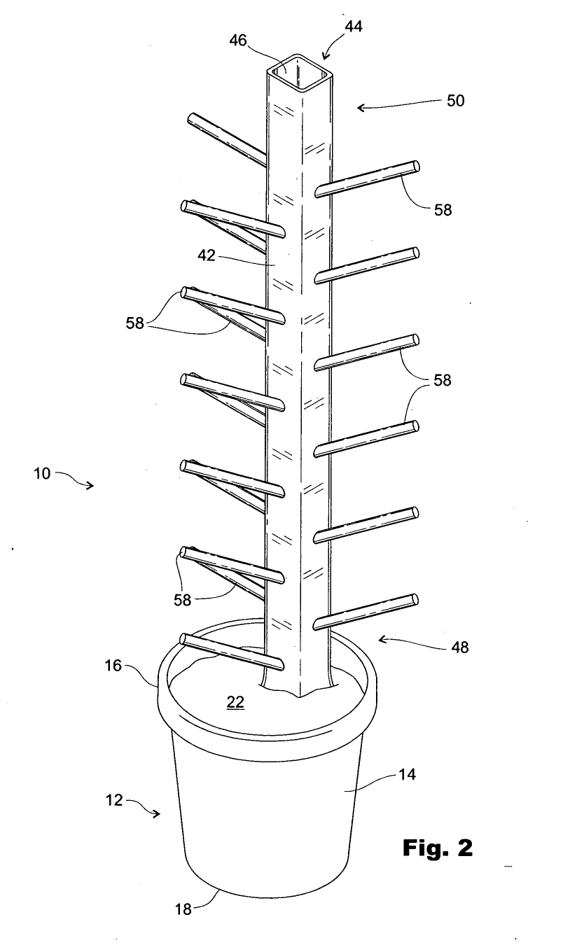

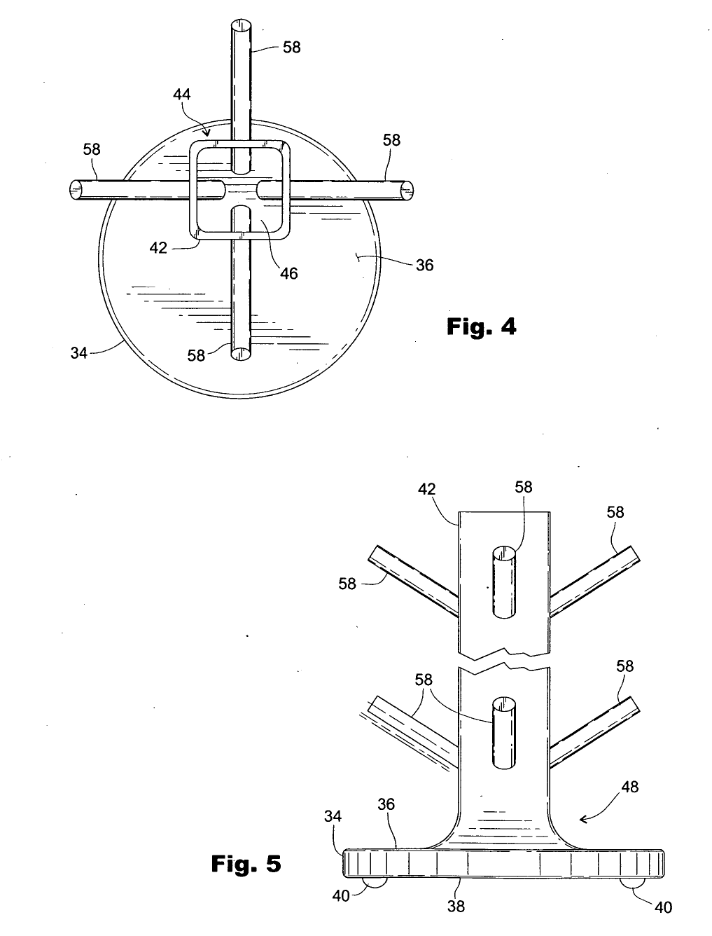

Illustrated in FIGS. 1-7 is a pot insert or flower pot plant hold up device 10 for training flora, such as plants, flowers, small trees, vines, and shrubs, to grow straight and tall. The device 10 can be used by homeowners, retail establishments, home and garden centers, nurseries; indeed, any place that has potted plants from shopping mall concourses and reception rooms to offices and public buildings, and where the straight, tall growth of the plants enhances their visual appeal and attractiveness.

Thus, shown in FIGS. 1-3 is a typical container or flowerpot 12 having a continuous sidewall 14, a circular upper rim 16, a flat bottom 18 (that may have drainage apertures), and a cavity 20 defined by the sidewall 14 wherein dirt 22 is placed and contained. A plant 24 is placed centrally within the dirt 22 and flowerpot 12 for growing therein, and the plant 24 includes a trunk or main stem 26, branches and limbs 28, and leaves 30 that grow from the limbs 28 (and sometimes the stem 26).

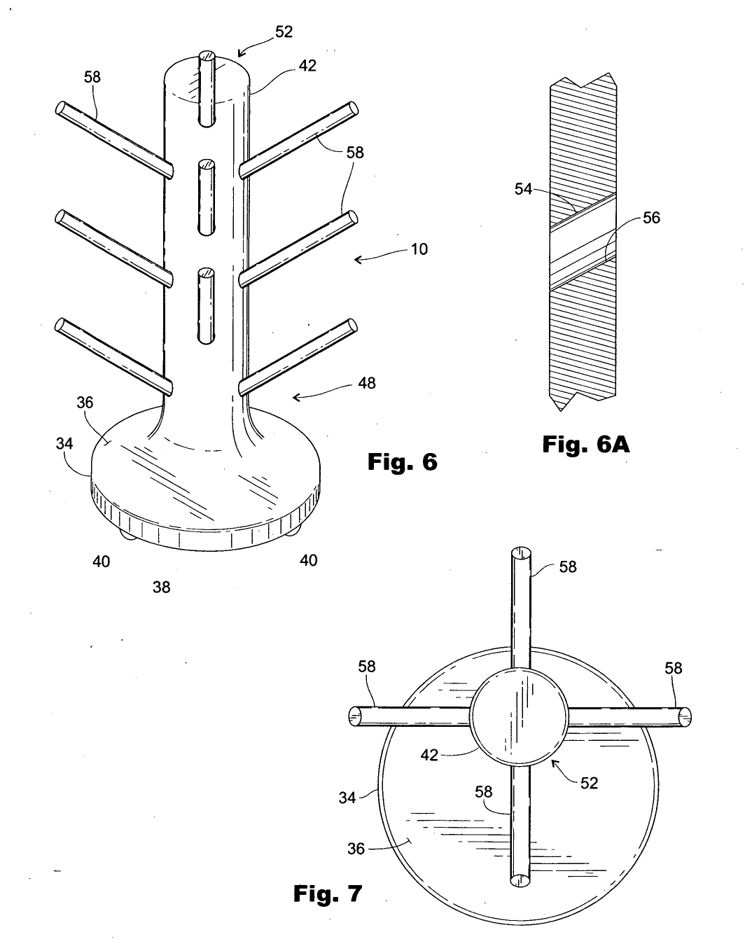

Illustrated in FIGS. 1-7 is the flower pot plant hold up device 10 that is inserted and placed within the flowerpot 12 for training the plant 24 to grow straight and tall. The device 10 includes a generally cylindrical-shaped base 34 having an upper surface 36 and an opposite bottom 38. Protruding from the bottom 38 is a plurality of spaced-apart bumper feet 40. The feet 40 dig slightly into the dirt 22 to help stabilize the device 10 within the flowerpot 12. Integrally attached or mounted to the base 34, and upwardly extending therefrom, is a support pole 42. The support pole 42 preferably has a height of four feet, and while it can be any geometric shape in cross section, as shown in FIGS. 1-4, a square-shaped configuration 44 that defines a hollow channel 46 coextensive in length with the support pole 42, is preferred for strength and stability. One preferred cross-sectional diameter for the support pole 42 having the square-shaped configuration is two and one half inches. The support pole 42 includes a lower end 48 adjacent the upper surface 36 of the base 34 and an opposite upper end 50. FIGS. 6 and 7 show an alternative circular-shaped cross sectional configuration 52 for the support pole 42. The support pole 42 is preferably composed of an extruded plastic material. The support pole 42 is offset or eccentrically located relative to the base 34—and the flowerpot 12—so that the plant 24 can be started and grown from the center of the flowerpot 12. The support pole 42 would interfere with the proper growth of the plant 24 if it were centrally located on the base 34.

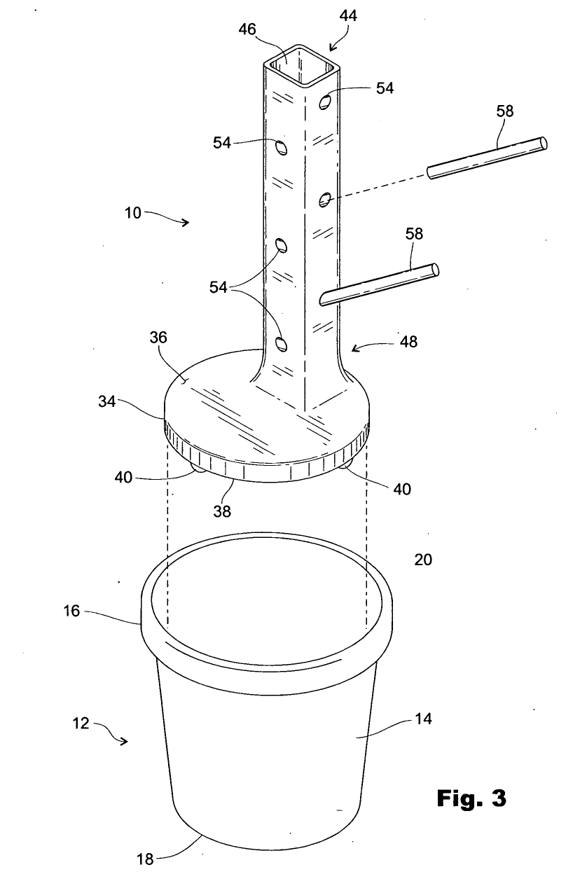

As shown in FIGS. 3 and 6, a plurality of apertures 54 are regularly spaced along the entire vertical extension of the support pole 42 from the lower end 48 to the upper end 50. One preferred spacing arrangement is for the apertures 54 on each side of the support pole 42 having the square-shaped configuration 44 to be spaced 12 inches from each other. Each aperture 54 includes an annular sidewall 56 sloped or angled at a 35-degree angle as shown in FIG. 6a. The apertures 54 are sized to receive arms or rods 58 with the arms 58 being at least 36 inches long. Moreover, the arms 58 are removably insertable to and partially within the apertures 54 so that depending on the growth of the plant 24, some or all of the apertures 54 can have arms 58 inserted therein and to which the desired parts of the plant 24 are tied to facilitate its straight and tall growth. Because of the sloped or angled configuration of the apertures 54, when inserted within the respective apertures 54 the arms 58 project outwardly at a 35-degree angle relative to the vertical extension of the support pole 42.

In use the base 34 would be placed within the cavity 20 of the flowerpot 12 and seated at the bottom of the flowerpot 12. Dirt 22 would then be placed in the flowerpot 12 covering the base 34 and the lower end 48 of the support pole 42. The plant 24 would be started and grown from the center of the flowerpot 12 because of the eccentric location and upward extension of the support pole 42 from the base 34. Arms 58 would be inserted into the selected apertures 54 as desired so that parts of the plant 24, such as the stem 26 or limbs 28, can be tied using string or cord 60 to the adjacent arms 58 thereby supporting the plant 24 and training the plant 24 to grow straight up alongside the support pole 42. As the plant 24 grows arms 58 can be added as desired to further support the plant's 24 upward growth, and arms 58 can be removed if they should be interfering with the growth of the plant 24. The various parts of the plant 24 can be untied from arms 58 or retied to selected arms 58 as needed thereby allowing the support pole 42 to both train and accommodate the upward straight and tall growth of the plant 24. Thus, the device 10 provides the individual with flexibility in adapting the device 32 to the growth of the plant 24 while avoiding any permanent attachment of the plant 24 to the support pole 42.

While the present invention has been described with respect to specific embodiments, it will be understood by those skilled in the art that various changes, modifications, and alterations are possible and practicable and will still be encompassed by the invention as set forth herein and will fall within the scope of the appended claims.

I claim:

1. A flower pot plant hold up device for training a plant to grow straight and tall, comprising:
a cylindrical-shaped base having a bottom and an opposite upper surface;
a plurality of bumper feet mounted to the bottom of the base;
an elongated support pole eccentrically mounted to the upper surface of the base;
the support pole having an upper end and an opposite lower end and having a square-shaped cross sectional configuration;
a plurality of apertures spaced along the support pole from the lower end to the upper end;
a plurality of arms insertably removable into the apertures and projecting outwardly therefrom at a 35 degree angle relative to the support pole; and
the plant being tied to the arms so that the plant is trained to grow upward straight and tall alongside the support pole.

2. The flower pot plant hold up device of claim 1 wherein the support pole can have a circular-shaped cross sectional configuration.

3. The flower pot plant hold up device of claim 2 wherein aperture includes an annular sidewall that is angled at 35 degrees relative to the support pole.

4. A flower pot plant hold up device placeable within a container for training a plant to grow up straight and tall, comprising:
a cylindrical-shaped base having a bottom and an opposite upper surface;
a plurality of bumper feet mounted to the bottom of the base;
an elongated support pole eccentrically mounted to the upper surface of the base so that the plant can be centrally located in the container;
the support pole having an upper end and an opposite lower end and having a square-shaped cross sectional configuration;
a plurality of apertures spaced along the support pole from the lower end to the upper end;
each aperture including an annular sidewall that is angled at 35 degrees relative to the vertical extension of the support pole;
a plurality of arms insertably removable into the apertures and projecting outwardly therefrom at an angle of 35 degrees relative to the vertical extension of the support pole; and
the plant being tied to the arms so that the plant is trained to grow upward straight and tall alongside the support pole.

5. The flower pot plant hold up device of claim 4 wherein the support pole can include a circular-shaped cross sectional configuration.
